(19) United States
(12) Patent Application Publication
(10) Pub. No.: US 2007/0285785 A1
(43) Pub. Date: Dec. 13, 2007

(54) Multiple-layer optical film having light concentrating and diffusing functions

(76) Inventor: Ching-Bin Lin, Taipei (TW)

Correspondence Address: Ching-Bin Lin, P. O. Box 55-846, Taipei, 104, omitted

(21) Appl. No.: 11/451,651

(22) Filed: Jun. 12, 2006

(51) Int. Cl. G02B 5/02

(52) U.S. Cl. 359/599; 359/831

(57) ABSTRACT

A multiple-layer optical film comprising: a transparent base layer, a diffusion layer formed on the base layer, and an upper prismatic layer formed on the diffusion layer having a plurality of root portions protruding downwardly from the upper prismatic layer to be respectively engaged with a plurality of recesses as recessed in the diffusion layer for firmly interlocking the upper prismatic layer with the diffusion layer. The diffusion layer includes nano or micron particles homogeneously dispersed in a resin matrix to obtain a composite layer having better light diffusibility; and the upper prismatic layer having nice light concentrating effect, thereby cooperatively synergetically forming a multiple-layer optical film having enhanced brightness, light uniformity, and dimensional stability.

### BACKGROUND OF THE INVENTION

U.S. Pat. No. 5,903,391 disclosed an optical film comprising a transparent substrate (1) and a light diffusion layer (2) formed on the substrate (1).

However, it is only consisting of a. diffusion layer (2) and a substrate layer (1). In order to increase sufficient brightness when used for liquid crystal display, it is required to be further combined with another optical material like prism lens such as to superimpose or stack plural optical films, sheets or elements for enhancing light diffusion and light concentrating functions, thereby increasing the production complexity, assembly inconvenience and installation cost when producing such conventional optical films.

The present inventor has found the drawbacks of the prior art and invented the present multiple-layer optical film with simpler way and lower cost.

### SUMMARY OF THE INVENTION

The object of the present invention is to provide a multiple-layer optical film comprising: a transparent base layer, a diffusion layer formed on the base layer, and an upper prismatic layer formed on the diffusion layer having a plurality of root portions protruding downwardly from the upper prismatic layer to be respectively engaged with a plurality of recesses as recessed in the diffusion layer for firmly interlocking the upper prismatic layer with the diffusion layer; with the diffusion layer having nano or micron particles homogeneously dispersed in a resin matrix to obtain a composite layer having better light diffusibility; and the upper prismatic layer having nice light concentrating effect, thereby cooperatively synergetically forming a multiple-layer optical film having enhanced brightness, light uniformity, and dimensional stability.

### BRIEF DESCRIPTION OF THE DRAWINGS

FIG. 1 shows a sectional drawing of the base layer of the present invention.

FIG. 2 is a sectional drawing of the present invention by forming the diffusion layer on the base layer of the present invention.

FIG. 3 shows the forming of a plurality of recesses as recessed in the diffusion layer of the present invention.

FIG. 4 is a sectional drawing of a first preferred embodiment of the present invention when laminating the three layers by forming the upper layer on that as shown in FIG. 3.

FIG. 5 is a sectional drawing of a diffusion layer of a second preferred embodiment of the present invention.

FIG. 6 is a sectional drawing when forming the upper layer on that as shown in FIG. 5.

FIG. 7 shows a sectional drawing of another diffusion layer of a third embodiment of the present invention.

FIG. 8 shows the sectional drawing when forming the upper layer on that as shown in FIG. 7.

FIG. 9 is a sectional drawing of still another composite diffusion layer of the present invention.

FIG. 10 is a sectional drawing when forming the upper layer on that as shown in FIG. 9.

### DETAILED DESCRIPTION

As shown in FIGS. 1-4, a multiple-layer optical film of the present invention comprises: a transparent base layer 1, a diffusion layer 2 formed on the base layer 1, and an upper prismatic layer 3 formed on the diffusion layer 2.

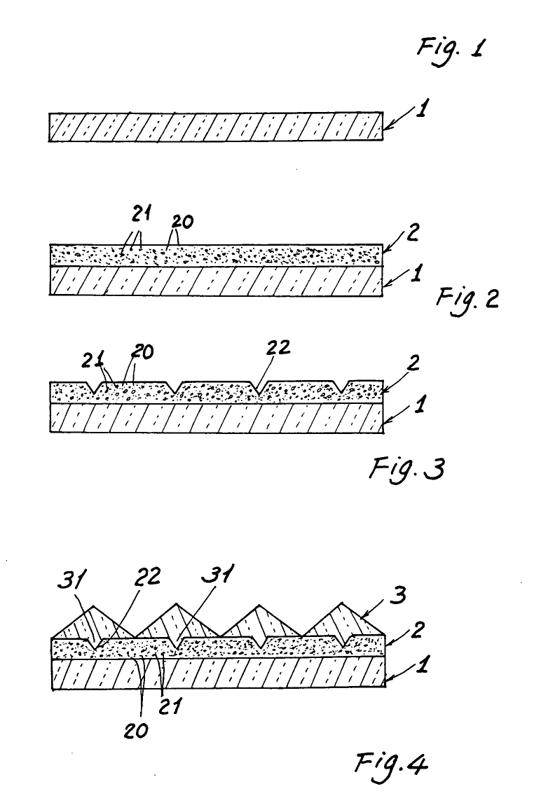

The diffusion layer 2 is formed by homogeneously dispersing nano or micron particles 21 in a photo-curing or thermosetting resin 20 to produce light diffusibility of the film 2, which is formed on the base layer 1 (FIG. 2).

The diffusion layer 2 is formed or imprinted with a plurality of recesses 22 recessed downwardly from the upper surface portion of the layer 2 as shown in FIG. 3.

The upper prismatic layer 3 as formed on the diffusion layer 2 includes a plurality of root portions 31 protruding downwardly from the upper prismatic layer 3 to be respectively engaged or interlocked with the plurality of recesses 22 as recessed in the diffusion layer 2 as shown in FIG. 4.

Each root portion 31 is preferably formed as a triangular shape tapered downwardly from the upper prismatic layer 3 as viewed from a sectional drawing of the optical film of the present invention (FIGS. 1-4).

However, the shapes of the root portion 31 are not limited in this invention, which may include triangular, arcuate, circular, rectangular and any other shapes.

The base layer 1 should be made clear, light transmissive, durable for resisting temperature fluctuations, for anti-aging, and also be made to have strong structural strength for uses in optical products including liquid crystal display, etc.

The base layer 1 may be made of the following most popularly used plastic or composite materials: Polyethylene Terephthalate (PET), polycarbonate (PC), styrene-acrylonitrile, cellulose acetate butyrate, cellulose acetate propionate, cellulose triacetate, polyether sulfone, polymethyl methacrylate, polyurethane, polyester, polyvinyl chloride, polystyrene, polyethylene naphthalate, etc.

The diffusion layer 2 and the upper prismatic layer 3 may be made of photo-curing resin or thermosetting (or heat-curing) resin, including ultraviolet (UV) curable resin. The resin may be hardened or cured when subjected to UV (ultraviolet) radiation or when heated by a heater.

The diffusion layer 2 may also be made of composite material having nano or micron particles incorporated or dispersed in matrix of thermoplastic or thermosetting resins.

The nano or micron particles 21 as homogeneously dispersed in the diffusion layer 2 may be selected from the group consisting of: calcium carbonate, barium sulfate, alumina, aluminum hydroxide, magnesium carbonate, zinc oxide, etc. The nano or micron particles 21 thus added into the resin 20 of the diffusion layer 2 may increase or regulate the refractive index or the light uniformity of the diffusion layer.

A process for making the multiple-layer optical film of the present invention comprises the steps of:
1. Coating a photo-curing resin or thermosetting resin of diffusion layer 2 on the base layer 1;
2. Forming or imprinting a plurality of recesses 22 in an upper surface portion of the diffusion layer 2, and hardening or curing the diffusion layer 2 by ultraviolet (UV) radiation or by heating by a heater; and
3. Forming or imprinting the upper prismatic layer 3 of photo-curing resin or thermosetting resin on the diffusion layer 2 by flowing, draining, impregnating, or filling the resin of the upper prismatic layer 3 into the recesses 22 in the diffusion layer 2; and hardening or curing the resin of the upper prismatic layer 3 on the diffusion layer by ultraviolet radiation or by heating (by a heater) to stably firmly engage or interlock the recesses 22 in the diffusion layer 2 with the root portions 31 of the upper prismatic layer 3 for interlocking the plural layers of the optical film of the present invention.

Accordingly, the present invention is superior to the prior art with the following advantages:
1. The diffusion layer 2 as intermediated in between the upper prismatic layer 3 and the base layer 1 will increase the light diffusibility of the optical film; while the upper prismatic layer 3 having the light concentrating effect, thereby synergetically enhancing the light uniformity and optical brightness of the optical film as produced in accordance with the preset invention, and thereby saving the complex stacking or superimposing process of a prismatic sheet with a diffusion sheet as required by the conventional art.
2. The root portions 31 engaged with the recesses 22 successfully “build” a firm stable “interlocking” mechanism among the upper prismatic layer 3, the diffusion layer 2 and the base layer 1 to greatly enhance the mechanical strength and dimensional stability of the optical film thus formed, thereby being durable for environmental fluctuations and being preventive from warping, waving, buckling or deformation of the optical film.
3. The root portion 31, especially when formed as triangular shape, will help refract incidence light to approximate the on-axis of the prism of the upper prismatic layer 3 to thereby further increase the brightness of the optical film.

The present invention may be further modified without departing from the spirit and scope of the present invention.

For instance, the base layer 1 may be eliminated in some production situations or commercial considerations. Some modifications of the present invention have been made as hereinafter described.

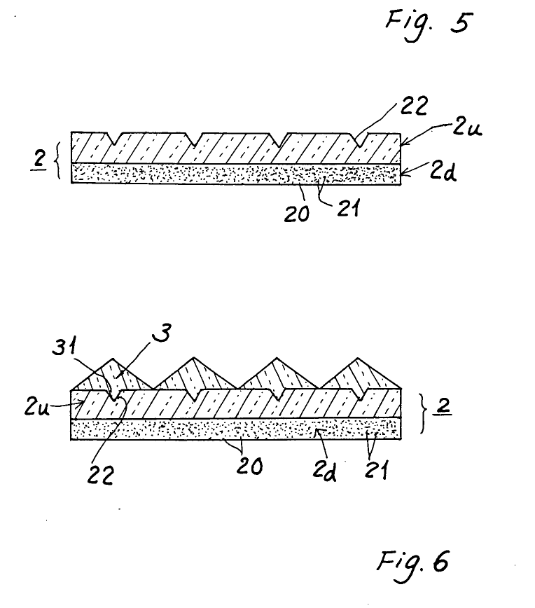

As shown in FIGS. 5 and 6, a second preferred embodiment of the present invention is made by eliminating the base layer 1 as mentioned in the first embodiment as aforesaid with reference to FIGS. 1-4.

The process for making the optical film as shown in FIGS. 5 and 6 comprises the steps of:
1. Forming a diffusing sub-layer 2d on a lower portion of a diffusion layer 2 by homogeneously dispersing nano or micron particles 21 in a photo-curing or thermosetting resin 20 in the diffusing sub-layer 2d for increasing or regulating the refractive index of the diffusing sub-layer 2d;
2. Forming a locking sub-layer 2u on an upper portion of the diffusion layer 2 by forming or imprinting a plurality of recesses 22 recessed in the locking sub-layer 2u made of thermoplastic materials;
3. Forming or imprinting the upper prismatic layer 3 on the diffusion layer 2 by filling a photo-curing resin or a thermosetting resin of the upper prismatic layer 3 into the plurality of recesses 22 in the diffusion layer 2 to form a plurality of root portions 31 of the upper prismatic layer 3, and hardening or curing the resin of the upper prismatic layer 3 for firmly engaging each said recess 22 in said diffusion layer 2 with each root portion 31 of said upper prismatic layer 3 for interlocking the upper prismatic layer 3 with the diffusion layer 2.

Other composite materials or light diffusive materials for making the diffusion layer 2 may be selected or used in this invention.

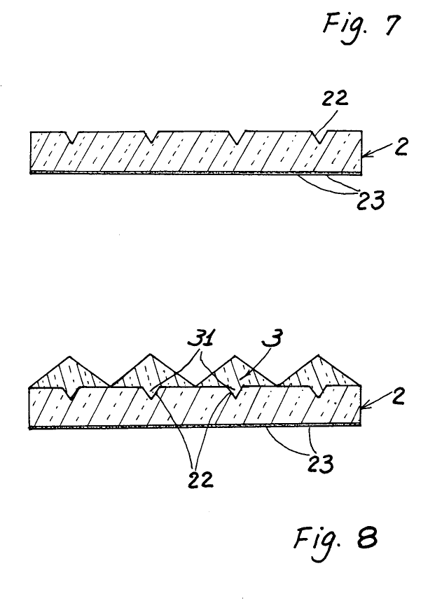

As shown in FIGS. 7 and 8, the diffusing sub-layer 2d (as shown in FIG. 6) has been modified to be a diffusing surface 23 by engraving, roughening, polishing or imprinting a bottom diffusing surface of the diffusion layer 2 to have roughness to increase the light diffusibility of the diffusion layer 2. The upper portion of the diffusion layer 2 is also formed with a plurality of recesses 22 to be engaged or interlocked with the root portions 31 of the upper prismatic layer 3 as aforementioned.

The diffusing sub-layer 2d, even being roughened, is expected not to form a plurality of acute peaks to prevent from scratching or damaging other optical films or optical elements when contacted with such a roughened diffusing surface 23 of the optical film of the present invention thus obtained.

The roughened diffusing surface 23 of the optical film as shown in FIG. 8 may be formed for randomly distributing the light transmitting directions or orientations as outwardly refracted through the plurality of refracting surfaces as successively formed on the roughened layer 23, thereby enhancing the light uniformity as effected by the diffusion layer of the present invention.

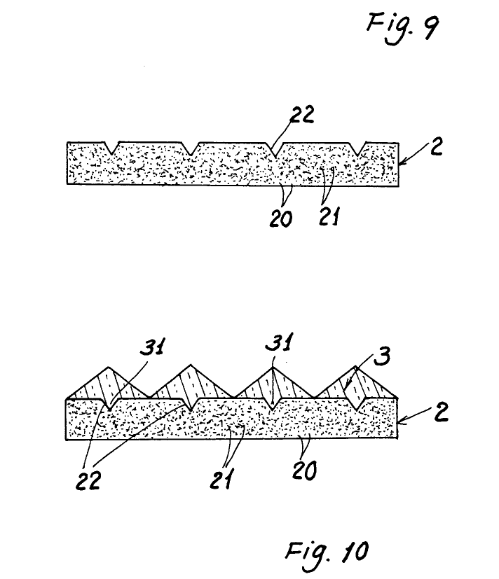

As shown in FIGS. 9 and 10, the diffusion layer 2, as interlocked with the upper prismatic layer 3, may be formed by homogeneously dispersing the nano or micron particles 21 in a photo-curing resin or thermosetting resin 20 to increase light diffusibility thereof; with an upper portion of the diffusion layer 2 formed with a plurality of recesses 22 (by molding or forming process) to be engaged with a plurality of root portions 31 of the upper prismatic layer 3 to thereby interlock the upper prismatic layer 3 with the diffusion layer 2 to form the optical layer having both light concentrating effect and light diffusing function.

The present invention provides an optical film having light diffusing function and light concentrating function as synergetically effected by the multiple-layer (or triple-layer) optical film formed in situ for enhancing the optical brightness and light uniformity, as well as increasing the mechanical strength and dimensional stability of the optical films durable for environmental fluctuations.

I claim:

1. A multiple-layer optical film comprising:
a base layer;
a light-diffusive diffusion layer formed on said base layer, and having nano or micron particles homogeneously dispersed in a photo-curing resin or thermosetting resin to increase light diffusibility thereof; and
a light-concentrating upper prismatic layer formed on said diffusion layer, and having a plurality of root portions protruding downwardly from said upper prismatic layer to be respectively engaged with a plurality of recesses as recessed in said diffusion layer to interlock said upper prismatic layer with said diffusion layer on said base layer to form an optical film synergetically having light diffusing effect and light concentrating effect.

2. A multiple-layer optical film according to claim 1, wherein said base layer is made of transparent materials including polycarbonate and polyethylene terephthalate.

3. A multiple-layer optical film according to claim 1, wherein each said root portion of said upper prismatic layer is formed as a triangular shape tapered downwardly from said upper prismatic layer.

4. A multiple-layer optical film according to claim 1, wherein said nano or micron particles are selected from the group consisting of: calcium carbonate, barium sulfate, alumina, aluminum hydroxide, magnesium carbonate, and zinc oxide.

5. A process for making multiple-layer optical film as set forth in claim 1 comprising the steps of:
A. Coating a photo-curing resin or thermosetting resin of said diffusion layer on the base layer;
B. Forming or imprinting a plurality of said recesses in an upper surface portion of the diffusion layer, and hardening or curing the diffusion layer; and
C. Forming or imprinting the upper prismatic layer of photo-curing resin or thermosetting resin on the diffusion layer by filling the resin of the upper prismatic layer into the recesses in the diffusion layer; and hardening or curing the resin of the upper prismatic player on the diffusion layer to engage the recesses in the diffusion layer with the root portions of the upper prismatic layer for interlocking the upper prismatic layer with said diffusion layer on said base layer for forming the optical film.

6. A multiple-layer optical film comprising:
a diffusion layer for increasing light diffusibility thereof; and
an upper prismatic layer formed on said diffusion layer, said upper prismatic layer having a plurality of root portions protruding downwardly from said upper prismatic layer to be engaged with a plurality of recesses formed in said diffusion layer for interlocking said upper prismatic layer with said diffusion layer for forming an optical film having increased light diffusibility and brightness thereof.

7. A process for making multiple-layer optical film as set forth in claim 6 comprising the steps of:
A. Forming a diffusing sub-layer on a lower portion of said diffusion layer for increasing a light diffusibility thereof;
B. Forming a locking sub-layer on an upper portion of the diffusion layer by forming or imprinting a plurality of recesses recessed in the locking sub-layer;
C. Forming or imprinting the upper prismatic layer on the diffusion layer by filling a photo-curing resin or a thermosetting resin of the upper prismatic layer into the plurality of recesses in said diffusion layer to form a plurality of root portions of the upper prismatic layer, and hardening or curing the resin of the upper prismatic layer for firmly engaging each said recess in said diffusion layer with each said root portion of said upper prismatic layer for interlocking the upper prismatic layer with the diffusion layer.

8. A process according to claim 7, wherein said locking sub-layer is formed by imprinting a plurality of said recesses in the upper portion of said diffusion layer which is made of thermoplastic resin; and said locking sub-layer laminated on said diffusing sub-layer for forming said diffusion layer.

9. A process according to claim 7, wherein said diffusing sub-layer is formed by homogeneously dispersing nano or micron particles in a photo-curing resin or thermosetting resin and by coating said resin of said diffusing sub-layer on a bottom of said locking sub-layer for forming said diffusion layer.

10. A process according to claim 7, wherein said diffusion sub-layer is formed by imprinting or forming a light-diffusive roughened surface on a bottom of said locking sub-layer.

11. A process for making multiple-layer optical film as set forth in claim 6 comprising the steps of:
A. Forming or imprinting a plurality of recesses in an upper portion of said diffusion layer, which is formed by homogeneously dispersing nano or micron particles in a thermoplastic resin for diffusing or scattering light; and
B. Forming or imprinting the upper prismatic layer on said diffusion layer by filling a photo-curing resin or thermosetting resin of the upper prismatic layer into said plurality of recesses in said diffusion layer to form a plurality of root portions of said upper prismatic layer; and curing the resin of said upper prismatic layer for engaging each said root portion of said upper prismatic layer with each said recess in said diffusion layer for interlocking said upper prismatic layer with said diffusion layer.
